(19) United States
(12) Patent Application Publication
(10) Pub. No.: US 2015/0359237 A1
(43) Pub. Date: Dec. 17, 2015

(54) Process for packaging young fresh coconuts to enhance the consumer satisfaction

(71) Applicant: Tropic Sol LLC, Brandon, FL (US)

(72) Inventor: Michael Brown, Brandon, FL (US)

(73) Assignee: TROPIC SOL LLC, Brandon, FL (US)

(21) Appl. No.: 14/303,224

(22) Filed: Jun. 12, 2014

(51) Int. Cl. A23B 7/16

(52) U.S. Cl. CPC A23B 7/16; A23V 2002/00

(57) ABSTRACT

Disclosed is a process for packaging a young fresh coconut in a brand labeled net bag. The process comprises of dehusking the selected young fresh coconut and then immediately dipping the firm inner nutshell in food-grade water based anti-oxidant solution. Further, the selected young fresh coconut is air-dried by refrigerating the firm inner nutshell and immediately processing the refrigerated inner nutshell through an automated shrink wrap heat tunnel to seal the coconut in a heat shrinkable plastic film. Further, the sealed young fresh coconut is then encased in a brand labeled net bag that has a specialized drinking straw inserted between the product labels at the top-end of the net bag. Further, the drinking straws can be unflavored or embedded with flavors designed with one pointed-end used to puncture the eye of the coconut to allow the consumer to immediately consume the fresh coconut water.

### BACKGROUND

### Field of the Invention

The present invention relates to packaging young fresh coconuts and more particularly relates to packaging young fresh coconuts to enhance the consumer satisfaction.

Young fresh coconuts are consumed regularly in some tropical countries such as India, Malaysia, Indonesia, and Vietnam mainly for its medicinal, culinary, and nonculinary uses. Expanding beyond the tropics where young fresh coconuts are prized for their healthy and thirst quenching water, increasing consumer demand has spurred on increasing sales of the processed coconut water. Once removed and exposed to the environment the coconut water becomes highly perishable. Shipping the young fresh coconut in its natural state is uneconomical because of it weight, size and limited shelf-life. It is required to process and pasteurize coconut water before storing in cans, bottles or boxes. Currently, the standard process followed to extend the shelf-life of the young fresh coconut water is through high heat pasteurization. The process of pasteurizing the young fresh coconut water diminishes the flavor and its nutrients, which in turn reduces the consumer satisfaction.

In light of what is discussed above, there is a need and market demand to provide a more advanced way of packaging the young fresh coconut that is convenient to carry individual packed coconuts by preserving the flavor and nutrients of the natural young fresh coconut, which in turn enhances the consumer satisfaction.

### SUMMARY

The present invention comprises a process that satisfies the consumer demand for convenience in carrying the young fresh coconuts and sustaining optimum product quality by encasing a young fresh coconut in a brand labeled net bag, wherein the process comprises of selecting the young fresh coconut for packaging. Further, the process stores the selected young fresh coconut in a cool storage and dehusks all external fiber leaving only the internal nutshell, which holds sterile coconut water and fresh and tender coconut pulp. Further, the internal nutshell is dipped in a food-grade water based anti-oxidant solution after dehusking to prohibit oxidation and sustain the natural white color of the internal nutshell. After dipping the young fresh coconut in the food-grade water based anti-oxidant solution, the young fresh coconut is air-dried in clean refrigerated storage, 35 F.-40 F. Further, the young fresh coconut is processed by passing through an automated shrink wrap heat tunnel to completely seal the white nutshell in the food grade plastic. Further, the sealed young fresh coconut is encased in a brand labeled net bag that includes a specialized drinking straw wrapped in a plastic inserted in between the logo label at the top of the bag. The bottom of the net bag is clipped and sealed. The drinking straw is an extra firm and serrated tube that allows the consumer to puncture the young fresh coconut through the soft eye seen at the top of the nutshell.

Other objects and advantages of the embodiments herein will become readily apparent from the following detailed description taken in conjunction with the accompanying drawings.

### BRIEF DESCRIPTION OF THE DRAWINGS

FIG. 1, according to an embodiment of the present invention, is an illustration of a young fresh coconut encased in a brand labeled net bag.

FIG. 2, according to an embodiment of the present invention, is an illustration of a flow chart that explains the process of encasing the young fresh coconut in the brand labeled net bag.

FIGS. 3a and 3b, according to an embodiment of the present invention, is an illustration of a straw inserted in the brand labeled net bag.

FIGS. 4a and 4b, according to an embodiment of the present invention, is an illustration of a straw with an angled cut along with a tooth pick end cased in the package used to puncture the eye of the young fresh coconut.

### FIGURES—REFERENCE NUMERALS

100-young fresh coconut

101-young fresh coconut enclosed in a brand labeled net bag

102-straw inserted in the young fresh coconut

### DETAILED DESCRIPTION

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

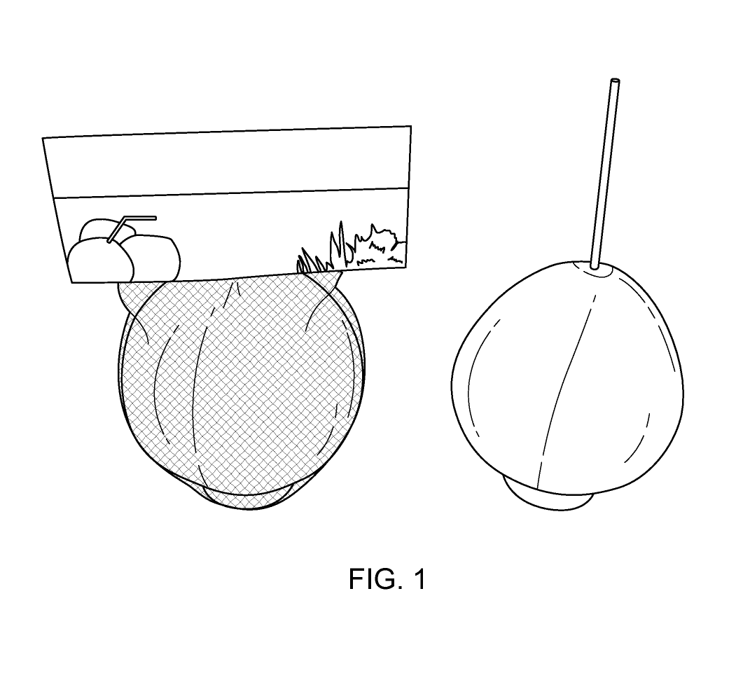

Referring to FIG. 1, the present invention comprises of a process used to encase a young fresh coconut 100 in a brand labeled net bag 101.

In an embodiment, before encasing the young fresh coconut in the brand labeled net bag 101 the young fresh coconut is completely sealed with a heat shrinkable polymer.

In an embodiment, the brand labeled net bag 101 that is sealed at the bottom can be used to carry the encased young fresh coconut individually. Further, the brand labeled net bag 101 comprises of a drinking straw 102 inserted at the top of the brand labeled net bag 101. In an embodiment, the drinking straw 102 is designed with a pointed-end/serrated to puncture one of the eyes of the young fresh coconut and the other end of the straw is used to draw tender coconut water to the mouth of the consumer.

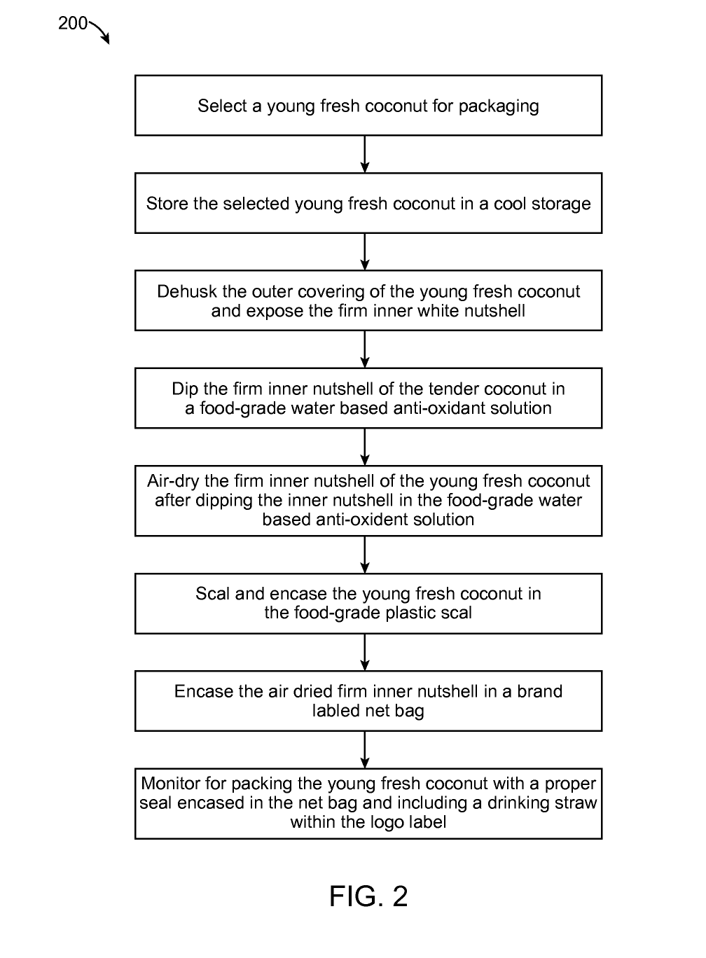

Referring to FIG. 2, the process 200 explains in detail the steps involved in packaging the young fresh coconut in the brand labeled net bag 101. At step 201, a young fresh coconut is selected for packaging. In an embodiment, the young fresh coconuts must be harvested between 7.5-9.0 months.

At step 202, the selected young fresh coconut is stored in a cold storage for couple of days. For example: the young fresh coconut can be stored in a refrigerator for a couple of days.

At step 203, the young fresh coconut is completely dehusked (all external fiber removed) and the inner nutshell of the young fresh coconut is exposed. At step 204, the firm inner nutshell of the young fresh coconut is dipped in the 3% food-grade water based anti-oxidant solution for 2 to 3 minutes to prevent oxidation of the inner nutshell and avoid the inner white nutshell turning brown due to oxidation. At step 205, the inner nutshell of the young fresh coconut is air-dried by refrigerating the inner nutshell with the temperature range set between 35 degree F. and 40 degree F. At step 206, the air-dried inner nutshell of the young fresh coconut is processed through an automated heat shrink wrap tunnel for sealing and encasing the young fresh coconut within a food-grade plastic seal.

In an embodiment, a hand held shrink wrap heating gun can be used to completely seal and encase the young fresh coconut in the food grade plastic seal.

At step 207, the sealed and encased young fresh coconut is placed in a single unit net bag with a logo label attached at the top of the bag and the bottom end of the bag is closed with a pressed clip. The pressed clip allows the consumer to carry the packaged young fresh coconut individually. Designed drinking straw is embedded in between the logo label at top of the net bag. At step 208, young fresh coconuts in the net bag are monitored for proper seal at the bottom of the bag and inclusion of a drinking straw within the logo label. After monitoring, the packaged young fresh coconuts are then packed in cartons for shipping.

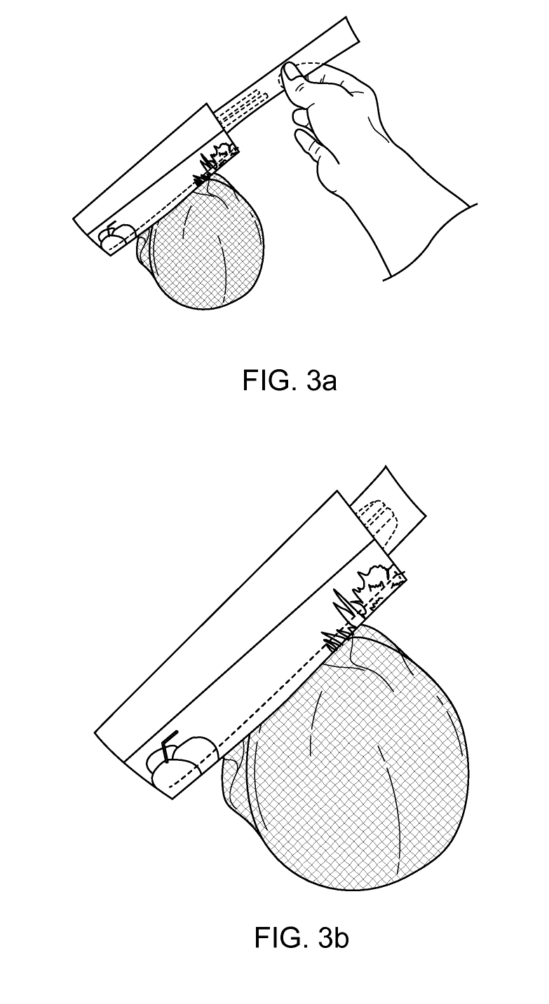

Referring to FIGS. 3a and 3b, the plastic wrapped drinking straw used to puncture the eye of the young fresh coconut is placed in between the product label and at the top of the brand labeled net bag 101.

In an embodiment, the drinking straw used to puncture the eye of the young fresh coconut can be unflavored or embedded with flavors along with a tooth pick end included in the package. In an embodiment, the drinking straw is wrapped individually in plastic and placed in between the product label and at the top of the brand labeled net bag 101.

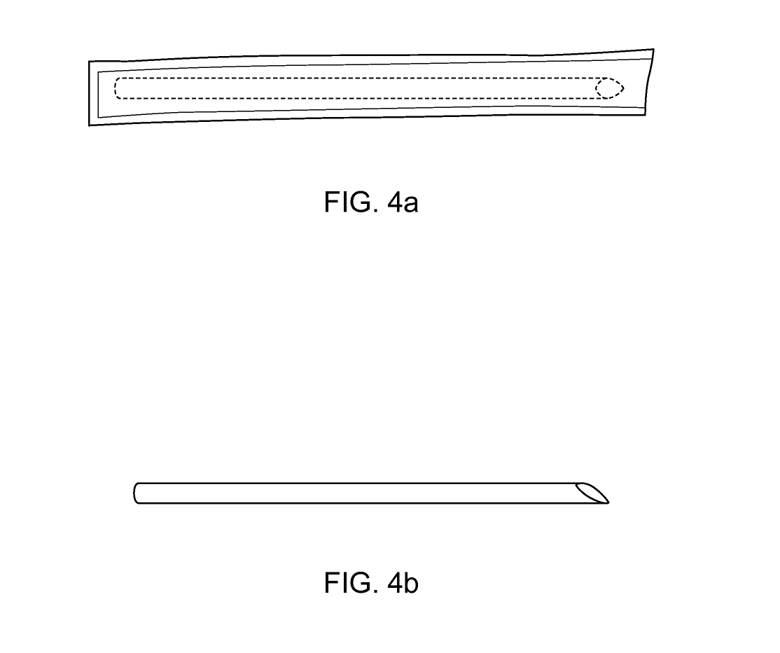

Referring to FIGS. 4a and 4b, the drinking straw inserted in between the product label and at the top of the brand labeled net bag 101 has a pointed-end/serrated that can be used to puncture the eyes of the young fresh coconut and the other end of the straw is used to draw coconut water to the mouth of the consumer.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the claims.

What is claimed is:

1. A process for encasing at least one young fresh coconut in a brand labeled net bag, wherein said process comprises of the following steps:
a. selecting said at least one young fresh coconut for packaging;
b. storing the selected said at least one young fresh coconut in a cool storage;
c. dehusking the outer covering of selected said at least one young fresh coconut;
d. dipping said at least one young fresh coconut in a 3% food-grade water based anti-oxidant solution after dehusking said at least one young fresh coconut;
e. air-drying said at least one young fresh coconut after dipping said at least one young fresh coconut in said anti-oxidant solution;
f. processing said at least one young fresh coconut by passing said at least one young fresh coconut through an automated shrink wrap heat tunnel for sealing said at least one young fresh coconut with said heat shrinkable plastic seal; and
g. encasing the processed said at least one young fresh coconut in a brand labeled net bag.

2. The process as claimed in claim 1, wherein said at least one young fresh coconut selected for packaging is harvested between 7.5-9.0 months.

3. The process as claimed in claim 1, wherein said at least one young fresh coconut selected for packaging is dehusked completely and the firm inner nutshell of said at least one young fresh coconut is exposed.

4. The process as claimed in claim 1, wherein said at least one young fresh coconut with said firm inner nutshell exposed is dipped in said 3% food-grade water based anti-oxidant solution such as sodium Metabisulfite for 2-3 minutes to prevent oxidation.

5. The process as claimed in claim 1, wherein said at least one young fresh coconut dipped in said anti-oxidant solution is air-dried by storing said at least one young fresh coconut in said cool storage such as a refrigerator, maintained at 35 degree F.-40 degree F. temperature.

6. The process as claimed in claim 1, wherein said package of said at least one young fresh coconut is sealed at the bottom and allows the user to carry said at least one young fresh coconut that is packaged individually.

7. The process as claimed in claim 6, wherein said package further comprises of a product label attached at top of said package with a drinking straw inserted in between said product label.

8. The process as claimed in claim 7, wherein said drinking straw inserted in between said product label comprises of a pointed-end to puncture at least one eye of said at least one tender coconut.
